(19) United States
(12) Patent Application Publication
(10) Pub. No.: US 2005/0066584 A1
(43) Pub. Date: Mar. 31, 2005

(54) Vehicle door frame and vehicle door equipped with a vehicle door frame

(76) Inventors: Michel Mounie, Saint Florent Le Jeune (FR); Francois Paul Meurou, Sceaux Du Gatinais (FR)

Correspondence Address: CARLSON, GASKEY & OLDS, P.C., 400 WEST MAPLE ROAD, SUITE 350, BIRMINGHAM, MI, 48009, US

(21) Appl. No.: 10/953,872

(22) Filed: Sep. 29, 2004

(30) Foreign Application Priority Data
Sep. 30, 2003 (FR) 03 11 426

(51) Int. Cl. B60J 5/04

(52) U.S. Cl. 49/502

(57) ABSTRACT

A frame for an automobile vehicle door includes a profiled section forming a top and sides of the frame. A lower end of each of the sides of the frame is thicker, in a direction transverse to a plane formed by the frame, than the remainder of the frame. An interface portion is fastened to the profiled section, and each of the lower ends of the sides of the frame is formed by the interface portion and the profiled section. The profiled section can be constructed with an appropriate cross-section for the strength requirements at the top of the frame, while reinforcing the part of the frame subjected to higher bending stresses.

### REFERENCE TO RELATED APPLICATION

This application claims priority to French Patent Application FR 03 11 426 filed on Sep. 30, 2003.

### BACKGROUND OF THE INVENTION

The present invention relates generally to a frame for an automobile vehicle door and to a vehicle door including the frame.

Vehicle doors can include a window glass frame that is embedded in a door shell or box section. The bending strength of the frame, transverse to a longitudinal axis of the vehicle, is determined (in the context of strength of materials) by the moment of inertia (referred to hereunder simply as the inertia) conferred upon legs of the frame embedded in the door shell. The inertia of the frame should be lower at the lower end of sides of the frame than at the top of the frame. A door frame should have a constant cross-sectional profile, which is typically obtained by extrusion. The size of the frame profile is determined by the inertia to be conferred on the lower end of the sides of the frame. Consequently, the top of the frame will have the same inertia as the sides of the frame, which leads to the top of the frame being larger than necessary. This has the disadvantage of increasing the weight of the vehicle door and the cost resulting from the excess material at the top of the frame.

There is consequently a need for a door frame which is lighter and less expensive.

### SUMMARY OF THE INVENTION

The present invention provides a frame for an automobile vehicle door including a profiled section forming a top and sides of the frame. A thickness at a lower end of each of the sides of the frame is greater, in a direction transverse to a plane formed by the frame, than a thickness of the remainder of the frame.

Each lower end of the sides of the frame is preferably formed by two anchoring members for anchoring the frame to the door. One of the anchoring members can be a profiled section. The profiled section preferably has a constant cross-sectional area.

The frame preferably further includes an interface portion fastened to the profiled section. The lower ends of the sides of the frame are each formed by the interface portion and the profiled section. The frame can further include a cut-out portion in a thickness of the frame that is near each of the lower ends. The interface portions are each fastened to the profiled section in one of the cut-out portions.

In one embodiment, the frame preferably has a slit or aperture extending in a direction parallel to the plane of the frame from each of the lower ends. Each lower end is formed by two half profiled sections spaced apart one from the other. As mentioned above, preferably, a thickness at the lower end of each of the two sides of the frame is greater, in a direction transverse to the frame, than the thickness of the remainder of the frame.

In one embodiment, the frame includes two interface portions each fastened to a profiled section in a cut-out portion. A lower end of each side of the frame is formed by the profiled section and the two interface portions. In this case, the frame can have a slit or aperture extending in a direction parallel to a plane of the frame from the lower end of each of the two sides. Each lower end of the two sides of the frame is formed by the two half profiled sections spaced one from the other. Preferably, the cut-out portion, or the slit or aperture, is masked by a window glass seal.

A vehicle door is also provided including a door shell and the above-described frame. The frame is secured to the door shell. A lower end of sides of the frame can be flared where they penetrate into the door shell. The profiled section keeps its constant cross-sectional area with this option. The interface portion can be a window glass slideway, and the interface portion can extend into the door shell following the curvature of a window glass.

Further characteristics and advantages of the invention will become clearer from the detailed description which follows of some embodiments provided solely by way of example and with reference to be attached drawings.

### BRIEF DESCRIPTION OF THE DRAWINGS

FIG. 1 is a perspective view of a door according to one embodiment of the invention;

FIG. 2 is a view in cross-section taken along line A-A of FIG. 1;

FIG. 3 is a view in cross-section taken along line B-B of FIG. 1;

FIG. 4 is a diagrammatic view in profile of the door of FIG. 1; and

FIG. 5 is a diagrammatic view of an alternate embodiment of the profile of the door in FIG. 1.

### DETAILED DESCRIPTION OF PREFERRED EMBODIMENTS

The invention provides an automobile vehicle door frame including a profiled section that forms the top and sides of the frame. A thickness at a lower end of the sides of the frame is greater, in a direction transverse to the plane formed by the frame, than a thickness of the remainder of the frame. Thus, the inertia of the frame is reinforced at the lower end of the sides by an interface portion. This makes it possible to manufacture the profiled section with dimensions adapted to the strength requirements of the top of the frame, while reinforcing the inertia of the part of the frame designed to be subject to the greatest bending forces. As the forces at the top of the frame are less imposing, the cross-sectional area of the profiled section can be reduced. The frame provides savings on materials and cost.

The longitudinal direction of the vehicle or its direction of travel is represented by X, a direction transverse to the direction of travel X is represented by Y, and the vertical direction of the vehicle is represented by Z.

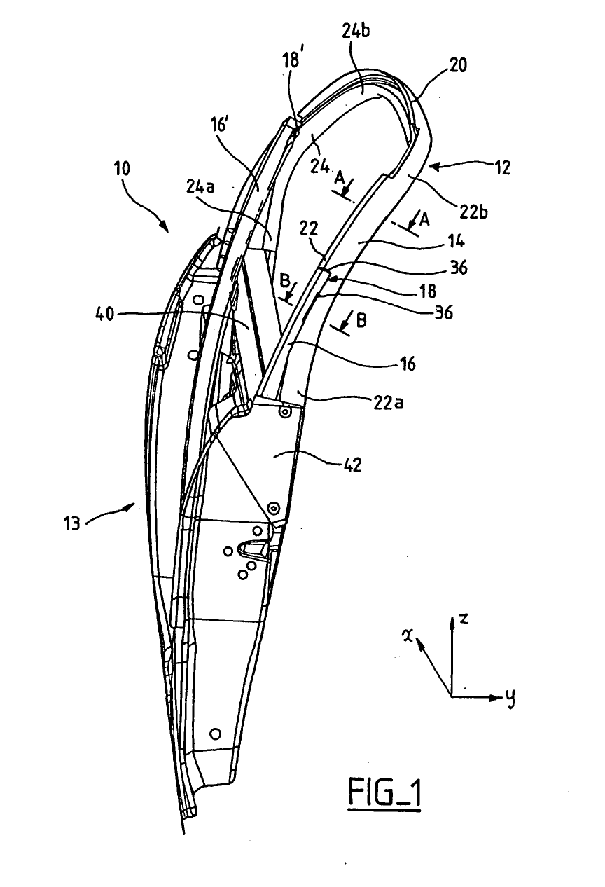

FIG. 1 is a perspective view of an automobile vehicle door 10. The door 10 includes a frame 12 embedded in a door shell 13. The frame 12 maintains a raised window glass in position and ensures sealing around the edges of the window glass. A profiled section 14 of the frame 12 forms a top 20 and sides 22 and 24 of the frame 12. The top 20 contacts the vehicle roof. Lower ends 22a and 24a of the sides 22 and 24 are embedded in the door shell 13. The sides 22 and 24 join the top 20 of the frame 12 at portions 22b and 24b, respectively. Preferably, the sides 22 and 24 and the top 20 form one continuous profiled section 14 having a one-piece construction. The sides 22 and 24 can be substantially vertical or can be inclined with respect to the vehicle. The lower ends 22a and 24a define the border between the door shell 13 and the frame 12. However, the frame 12 may be extended inside the door shell 13. The profiled section 14 is, for example, obtained by extrusion, deep drawing or bending.

The cross-sectional area of the profiled section 14 confers the minimum inertia upon the top 20 of the frame 12 to fulfil stiffness constraints required for the top 20 of the frame 12. For example, the top 20 of the frame 12 is sufficiently rigid to constrain the vehicle roof seal when the door is closed. The top 20 of the frame 12 is also sufficiently rigid to limit outwardly flexing in the direction Y. This particularly applies when the vehicle is travelling at a high speed, and the door frame 12 is pulled towards the outside of the vehicle. The cross-sectional area of the top 20 of the frame 12 is constant, making the frame 12 easier to construct. Further, as the cross-sectional area is determined as a function of the strength requirements for the top 20 of the frame 12, the top 20 of the frame 12 is now no longer too large, providing a savings on materials.

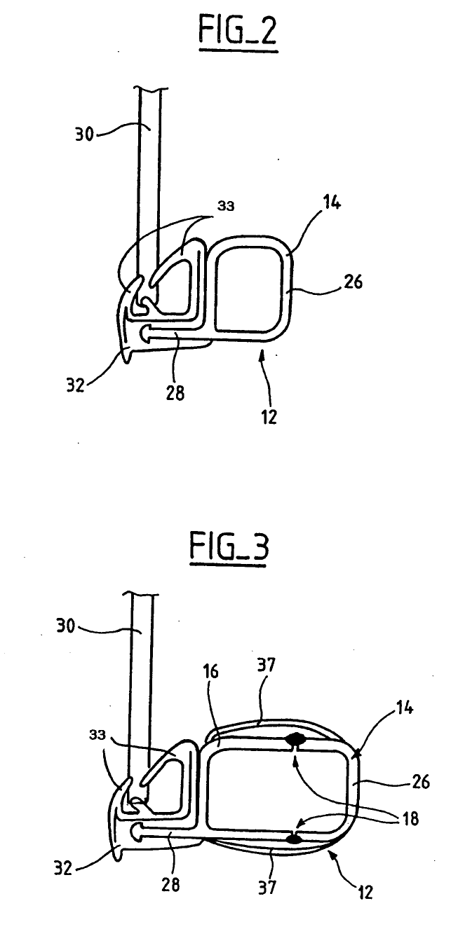

FIG. 2 is a cross-sectional view taken along line A-A of FIG. 1. FIG. 2 is an example of an embodiment of the profiled section 14 taken for illustrative purposes. The profiled section 14 has a shape that reduces the weight of the frame 12 and holds a seal 32 for a window glass 30 in place. The profiled section 14 includes an upright 26 having a tubular cross-section, for example square, to reduce the weight. A portion 28 extends from the upright 26 and into a slot in the seal 32 to hold the seal 32 in position. The frame 12 surrounds the window glass 30, which slides in a slot in the seal 32, and sealing contact is provided between the frame 12 and the window glass 30. The seal 32 may include lips 33 that ensure better contact with the window glass 30, even when movements transverse or parallel to the plane formed by the frame 12 are present, ensuring better overall sealing of the vehicle. Preferably, the seal 32 is present at the sides 22 and 24 and the top 20 of the frame 12 and along the periphery of the window glass 30 in the raised position.

A thickness is defined in the transverse direction Y of FIG. 1. In FIG. 2, the thickness is defined in the direction transverse to the plane of the window glass 30. The thickness of the frame 12 is determined starting from the free end of the portion 28 up to the opposite side of the upright 26. In FIG. 1, the thickness of each of the lower end 22a of the side 22 and the lower end 24a of the side 24 is greater than the thickness of the remainder of the frame 12. A lower portion of the sides 22 and 24 is thicker than the remainder of the frame 12. Correspondingly, the thickness of an upper portion of the sides 22 and 24, or the thickness of the top 20 of the frame 12, is less than the thickness of the lower ends 22a and 24a. The frame 12 is thicker in the regions where stresses are greatest and is less thick in the remainder of the frame 12 where stresses are lower. The greater thickness provides strength in the lower ends 22a and 22b of the sides 22 and 24 of the frame 12, while the remainder of the frame 12 is not reinforced or strengthened. Preferably, the frame 12 has a greater thickness at the lower ends 22a and 24a of the sides 22 and 24 and over less than half the length of the sides 22 and 24. The greater thickness present at the lower ends 22a and 24a of the frame 12 decreases while moving towards the top 20 of the frame 12 to reach the top thickness of the frame 12. The greater thickness, for example, extends over a length of the frame 12 chosen to approach isometric bending stress performance and to optimize performance and cost.

FIG. 1 shows one embodiment of the frame 12. The frame 12 includes an interface portion 16 fastened to the profiled section 14. The lower end 22a of the side 22 of the frame 12 is constituted by the interface portion 16 and the profiled section 14, making it possible to increase the thickness of the frame 12 at the lower end 22a of the side 22. Only the side 22 and the lower end 22a of the side 22 are described, although it is to be understood that the side 24 and the lower end 24a of the side 24 can have the same features. The thickness of the frame 12 effectively is increased in the direction transverse to the plane formed by the frame 12, increasing resistance to bending forces. The frame 12 includes a reinforcement at the lower end 22a of the side 22, while the remainder of the frame 12 is constituted by the profiled section 14 having a reduced thickness. This strengthens the frame 12 while saving on materials.

The frame 12 can include a cut-out portion 18 in the thickness of the frame 12 located near the lower end 22a of the side 22. The interface portion 16 is secured to the profiled section 14 in the cut-out portion 18. In FIG. 1, the cut-out portion 18 has been formed in the thickness of the side 22 of the frame 12 and is obtained by detaching a portion of the frame 12 with a cutting tool. Any technology can be used to form the cut-out portion 18, and the cut-out portion 18 can be obtained by machining or by the progressive removal of material. The cut-out portion 18 can be a recess formed in the frame 12 and can be formed perpendicular to the plane of the window glass 30 in the Y direction. The cut-out portion 18 can also be formed between the sides 22 and 24 of the frame 12 in the X direction and will then not be open at both sides 22 and 24 of the frame 12 in the X direction. That is, the cut-out portion 18 may or may not extend down to the lower end 22a of the side 22 of the frame 12. The cut-out portion 18 may be delimited, along the side 22, by two upper and lower ends which have the original thickness and could be called non-cut-out regions, or just include a region that is not cut-out above it.

The cut-out portion 18 allows the interface portion 16 to be fully combined, at least over a certain length, with the profiled section 14, providing a more continuous frame 12 which improves the aesthetic appeal of the frame 12 and also provides sealing. The cut-out portion 18 is near the lower end 22a of the side 22 of the frame 12. As the cut-out portion 18 is designed to receive a securing feature that allows the lower end 22a of the side 22 to be strengthened, the cut-out portion 18 is formed so as to allow the interface portion 16 to extend down to the lower end 22a of the side 22. Preferably, the cut-out portion 18 extends over less than half the length of the side 22. The cut-out portion 18 extends, for example, over a length chosen to provide an isometric bending stress performance profile and for optimizing performance/cost trade-off.

The interface portion 16 reinforces the inertia of the lower end 22a of the side 22. The frame 12 has a constant cross-sectional area dimensioned in correspondence with the forces the top 20 of the frame 12 must withstand, and the frame 12 is reinforced where it is anchored in the door shell 13. In the Y direction perpendicular to the window glass 30, the lower portion of the frame 12 made up by the profiled section 14 and the interface portion 16 has a greater moment of inertia than the upper portion of the frame 12 only made up by the profiled section 14, increasing the greater bending and torsional stiffness of the frame 12. This allows the frame 12 to withstand the bending and torsional stresses the frame 12 is subject to at the lower end 22a of the side 22, while saving on material over the remainder of the frame 12 where stresses are less imposing.

FIG. 3 shows a section of the frame 12 taken along the line B-B of FIG. 1. The frame 12 includes the profiled section 14 with the cut-out portion 18, together with the interface portion 16. The interface portion 16 is, for example, an extruded or deep drawn profiled section. The interface portion 16 forms an extension of the profiled section 14, and completes the tubular cross section of the profiled section 14. As the cut-out portion 18 gives the profiled section 14 a U-shaped cross section, the interface portion 16 has a matching U-shaped cross section. The interface portion 16 can also have a square cross section.

As in FIG. 1, the frame 12 can be bowed, and the cut-out portion 18 can be provided on the convex side directed towards the inside of the vehicle. Thus, the cut-out portion 18 is less prejudicial to vehicle sealing as there is a continuous path of sealing over the periphery of the frame 12. FIG. 3 illustrates that the interface portion 16 supports and extends the portion 28. Preferably, the seal 32 extends along the interface portion 16 to guarantee better sealing. FIG. 1 illustrates that the frame 12 is bowed to increase space inside the vehicle. For this purpose, the inner wall of the door shell 13 can be substantially vertical while the frame 12 can extend obliquely towards the vehicle roof. The profiled section 14 is substantially vertical where it is embedded in the door shell 13 and is inclined in the direction of the roof. The interface portion 16 is initially integral with the profiled section 14 over the part inclined towards the roof of the profiled section 14. The interface portion 16 then extends tangentially to the profiled section 14 when the profiled section 14 is straightened out to enter the door shell 13. The interface portion 16 extends into the door shell 13 following the curvature of the surface of the window glass 30, thus progressively moving away from the profiled section 14. The interface portion 16 thus makes it possible to increase the thickness of the frame 12 at the lower end 22a of the side 22 in the Y direction. At the lower end or base of the frame 12, the thickness of the frame 12 includes the thickness of the profiled section 14 along with the thickness of the interface portion 16.

Increasing the frame 12 thickness in the Y direction stiffens the base of the frame 12 at the door shell 13 against bending stresses in the Y direction, or torsional stresses about the Z direction. Thus, the profiled section 14 of the frame 12 is dimensioned as a function of the minimum inertia at the top 20 of the frame 12, and the interface portion 16 assembled to the profiled section 14 increases frame inertia, at least at the border of the frame 12 with the door shell 13. The thickness of the frame 12 is increased while avoiding the need to make the top 20 of the frame 12 larger than necessary, reducing the amount of material used.

The interface portion 16 can be secured to the frame 12 by welding, and weld lines 36 are shown in FIG. 1. To improve aesthetic appeal and acoustics of the frame 12, the cut-out portion 18 can be masked by one or several trims 37. An alternate to the trim 37 is to extend the window glass seal 32 towards the profiled section 14 to cover the weld lines 36 and incorporate the trim 37. This is advantageous because the same part simultaneously provides sealing and masking. The fact that the cut-out portion 18 creates an irregularity, masked by the seal 32, has no effect from the sealing aspect. Further, the seal 32 also ensures that the presence of the cut-out portion 18 has no effect on guiding of the window glass 30. The door can be assembled more rapidly. Masking may also only be partial, either inside or outside the frame 12.

Preferably, the frame 12 includes two cut-out portions 18 and 18′ which are each designed to receive an interface portion 16 and 16′. The two interface portions 16 and 16′ are each fastened by the profiled section 14 in the cut-out portions 18 and 18′. Each lower end 22a and 24a of the sides 22 and 24 is, respectively, formed by the profiled section 14 and one of the interface portions 16 and 16′, respectively. The lower ends 22a and 24a of the sides 22 and 24 of the frame 12 are each formed from the profiled section 14 and one of the two interface portions 16 and 16′, respectively. Thus, the frame 12 is reinforced at the lower ends 22a and 24a of both sides 22 and 24, while the remainder of the frame 12 has a minimum cross-sectional area to reduce the amount of material employed.

As shown in FIG. 1, the door includes a door shell 13 defined between an inner skin directed towards the inside of the passenger compartment and an outer skin directed away from the passenger compartment. The frame 12 is embedded in the door shell 13 and incorporates door equipment, such as a window regulator, loudspeakers or a door lock (not shown). The door shell 13 also receives the window glass 30 when the window glass 30 is lowered. The window glass 30 moves linearly by the window regulator and is guided during its linear movement by one or two slideways. The slideways guide the window glass 30 both inside the door shell 13 and outside the door shell 13. Preferably, the interface portion 16 is a slideway, and preferably both interface portions 16 and 16′ are slideways. The interface portions 16 and 16′ extend inside the door shell 13 and along the frame 12, making it possible to reinforce the base of the frame 12 against bending forces because the interface portions 16 and 16′ have greater bending strength. Further, using one or two interface portions 16 and 16′ for the slideways makes it possible to employ parts that are already present on the door.

In FIG. 1, the door includes a strengthener 40 to make the door 10 more rigid, in particular in the possible event of a head-on impact, and also increases frame rigidity. The strengthener 40, for example, extends at the top of the door shell 13 beneath the frame 12, and may be a rectangular cross-section beam, as an example. The strengthener 40 extends in the X direction between the lower ends 22a and 24a of the frame 12. The interface portions 16 and 16′ can extend from the inside of the frame 12 and run around the strengthener 40 at the outer skin side of the door shell 13. This is preferable when the interface portions 16 and 16′ act as window glass slideways. The profiled section 14 can extend towards the inside of the door shell 13, bypassing the strengthener 40 along the side of the door shell 13 inner skin.

This allows the frame 12 to extend inside the door shell 13 and to enclose the strengthener 40, thereby increasing the bending rigidity. Alternatively, the profiled section 14 can stop at the strengthener 40 for more ready incorporation.

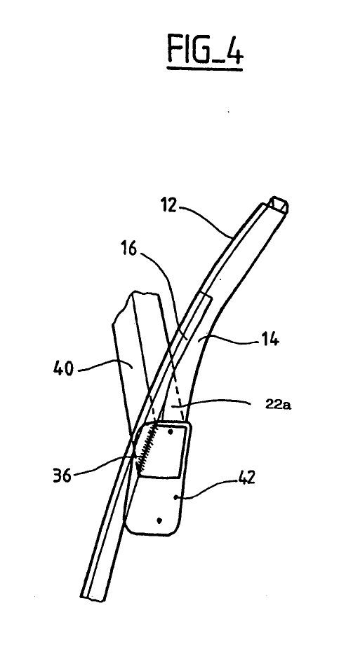

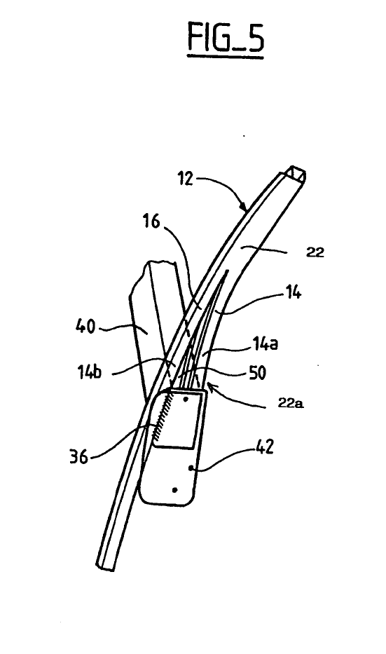

FIG. 4 is a diagrammatic view of the door of FIG. 1 in profile. The profiled section 14, the cut-out portion 18, the interface portion 16 secured to the profiled section 14 at the cut-out portion 18, and the strengthener 40 are shown. The interface portion 16 extends into the door shell 13, bypassing the strengthener 40. The profiled section 14 is welded, at its lower end, to the strengthener 40. The interface portion 16 can be adjacent to a side of the strengthener 40 and secured there, for example, by the weld line 36. This increases the stiffness of the interface portion 16 and the stiffness of the frame 12 at the lower end 22a.

FIG. 5 is a diagrammatic view of an alternate embodiment of the profile of the door of FIG. 1. In a direction parallel to the plane of the frame 12, the frame 12 has a slit or aperture 50 extending from the lower end 22a of the side 22. The lower end 22a of the side 22 of the frame 12 is formed by two half profiled sections 14a and 14b that are spaced apart. Compared to the embodiment of FIG. 1, the half profiled section 14a has the same advantages as the profiled section 14, and the half profiled section 14b has the same advantages as the interface portion 16. In particular, the half profiled section 14b can act as a window glass slideway.

Dividing up the profiled section of the door frame 12 into a half profiled section 14a that acts as an inner profiled section 14 and a half profiled section 14b that acts as a window glass slideway can be achieved by splitting the profiled section 14 in a plane parallel to the window glass surface. The two half profiled sections 14a and 14b are spaced one from the other. The trims 37 can block off the opening formed by the presence of the slit or aperture 50. The side 24 can also have the same configuration.

FIGS. 1, 4 and 5 show a securing part 42 that secures the profiled section 14 and, if necessary, the interface portion 16 to the strengthener 40. The securing part 42 is, for example, a portion of the edge wall of the door shell 13. The securing part 42 can be secured to the profiled section 14, the interface portion 16 and the strengthener 40 by screwing, welding or some other structural assembly method.

In FIGS. 1, 4 and 5, the frame 12 is shown as being embedded in the door shell 13. The lower end of the side 22, or of the sides 22 and 24, of the frame 12 is constituted by two members for anchoring the frame 12 to the door. The anchoring members are arranged in the Y direction. In FIGS. 1 and 4, the anchoring members are the profiled section 14 and the interface portion 16. In FIG. 5, the anchoring members are the profiled section 14 divided into two half profiled sections 14a and 14b. This ensures better stability in a plane perpendicular to the plane of the frame 12 and containing the Y direction. The anchoring members increase the thickness of the frame 12 in the Y direction.

The frame 12 is thus fastened at the lower ends 22a and 24a by being embedded in the door shell 13 and is free at its other end at the top 20 of the frame 12. The base of the frame 12 is secured and held in a cantilevered fashion by the door shell 13. The frame 12 can extend into the door shell 13 beyond the border, or junction, between the frame 12 and the door shell 13. In particular, the interface portion or portions 16 and 16′ or the half profiled section 14b can extend into the door shell 13. The frame 12 is, for example, inserted into the door shell 13 through the top edge of the door shell 13.

As the door shell 13 is thicker in the Y direction than the frame 12, a discontinuity is present at the border between the frame 12 and the door shell 13. The lower end 22a of the side 22 of the frame 12 constituted by the profiled section 14, the interface portion 16, and the half profiled sections 14a and 14b, which act as anchoring members, allow the lower end 22a of the side 22 of the frame 12 to flare as it penetrates into the door shell 13. The profiled section 14 in FIG. 4, or respectively, the half profiled section 14a in FIG. 5, can penetrate into the door shell 13 along the inner skin of the door shell 13, ensuring better continuity of the inner wall of the door 10. The interface portion 16 in FIG. 4, and respectively the half profiled section 14b in FIG. 5, penetrate in oblique fashion into the door shell 13 parallel to the window glass 30. The interface portion 16 or the half profiled section 14b follow the convex or bulging shape of the door shell 13 better and ensure continuity between the door shell 13 and the frame 12 at the outer wall of the door 10. This provides better continuity of the inner and outer walls of the door 10. Thus, it is easier to ensure sealing for the door 10 in the region where the frame 12 penetrates into the door shell 13.

The invention is not limited to the embodiments described by way of example. Thus, the interface portion 16 can have a greater cross-section than the cross section of the profiled section 14. The interface portion 16 can then be arranged in overlapping fashion with the profiled section 14. Further, the securing part 42 is a patentable feature independent of the increase in the frame 12 thickness.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A frame for an automobile vehicle door, the frame comprising:
a profiled section forming a top and two sides of the frame, the two sides of the frame each including a lower end having a thickness, the profiled section defining a plane, wherein the thickness is defined in a direction transverse to the plane, and the thickness of the lower ends of each of the two sides of the frame is greater than a thickness of a remainder of the frame.

2. The frame according to claim 1, wherein the lower ends of the two sides of the frame each define two anchoring members for anchoring the frame to an automobile vehicle door.

3. The frame according to claim 2, wherein one of the two anchoring members is the profiled section.

4. The frame according to claim 1, wherein the profiled section has a substantially constant cross-sectional area.

5. The frame according to claim 1, further including an interface portion fastened to the profiled section, wherein each of the lower ends of the two sides of the frame is formed by one of the interface portion and the profiled section.

6. The frame according to claim 5, further including a cut-out portion located near each of the lower ends of the two sides of the frame, wherein each interface portion is fastened to the profiled section in the cut-out portion.

7. The frame according to claim 1, further including an aperture extending from each of the lower ends of the two sides of the frame in a direction parallel to the plane to define two half profiled sections, wherein each of the lower ends of the two sides of the frame is formed by the two half profiled sections.

8. The frame according to claim 1, wherein the thickness of each of the lower ends of the two sides of the frame is greater than the thickness of the remainder of the frame in a direction transverse to the frame.

9. The frame according to claim 1, wherein each of the two sides of the frame includes a cut-out portion and an interface portion, and each interface portion is fastened to the profiled section in one of the cut-out portions, and wherein the lower ends of the two sides of the frame are each formed by the profiled section and one of the interface portions.

10. The frame according to claim 9, further including an aperture extending from each of the lower ends of the two sides of the frame in a direction parallel to the plane to define two half profiled sections, wherein each of the lower ends of the two sides of the frame is formed by the two half profiled sections.

11. The frame according to claim 10, further including a window glass seal, wherein one of the cut-out portions and the apertures is masked by the window glass seal.

12. A vehicle door comprising:
a door shell; and
a frame secured to the door shell, the frame including:
a profiled section forming a top and two sides of the frame, the two sides of the frame each including a lower end having a thickness, the profiled section defining a plane, wherein the thickness is defined in a direction transverse to the plane, and the thickness of the lower ends of each of the two sides of the frame is greater than a thickness of a remainder of the frame, and
an interface portion fastened to the profiled section, wherein each of the lower ends of the two sides of the frame is formed by the interface portion and the profiled section.

13. The vehicle door according to claim 12, wherein each of the lower ends of the two sides of the frame has a constant cross-sectional area, wherein the frame is flared at a location where the frame penetrates into the door shell.

14. The vehicle door according to claim 12, wherein the interface portion is a window glass slideway.

15. The vehicle door according to claim 12, further including a window glass, wherein the interface portion extends into the door shell and follows a curvature of the window glass.
